(19) United States
(12) Patent Application Publication
(10) Pub. No.: US 2008/0168370 A1
(43) Pub. Date: Jul. 10, 2008

(54) Method and System for Providing Alerts to Clients Engaging in Security or Commodity Trading

(75) Inventors: Michael J. Maher, Garden City, NY (US); Dean Stamos, Bay Head, NJ (US)

Correspondence Address: NORRIS, MCLAUGHLIN & MARCUS, 875 THIRD AVE, 18TH FLOOR, NEW YORK, NY, 10022, US

(73) Assignee: InfoExchange, Inc., New York, NY (US)

(21) Appl. No.: 11/970,810

(22) Filed: Jan. 8, 2008

Related U.S. Application Data
(60) Provisional application No. 60/883,923, filed on Jan. 8, 2007.
(60) Provisional application No. 60/951,870, filed on Jul. 25, 2007.

(51) Int. Cl. G06F 3/048; G06Q 99/00; G06Q 40/00; H04L 9/32; G06F 17/30; G06F 21/24; G06F 15/16

(52) U.S. Cl. 715/764; 705/1; 705/36 R; 709/206; 709/201; 726/1; 726/4; 707/104.1; 707/E17.009

(57) ABSTRACT

A system and a method for monitoring and evaluating trading opportunities in financial or commodity products is disclosed. Clients are provided, based on their current and/or historic trading pattern, with targeted, up-to-date information about financial products and services. This information provided to the client is client-specific and confidential, subject to access control, such as preauthorization and user authentication. The information provided to the clients is filtered so as to eliminate “noise”, i.e., information that would be of little or no interest to the client.

### CROSS-REFERENCE TO RELATED APPLICATIONS

This application claims the benefit of U.S. provisional applications Ser. Nos. 60/883,923, filed on Jan. 8, 2007, and 60/951,870, filed Jul. 25, 2007, the entire contents of which are incorporated herein by reference.

### FIELD OF THE INVENTION

The present invention relates to a method and system for providing financial information in a communication network, and more particularly to a method and system for enhancing information flow by supplying clients with information/product/services relevant to their trades in securities, services and/or commodities.

### BACKGROUND OF THE INVENTION

An increasing number of orders to purchase and sell securities, in particular trades by institutional investment management firms, are now communicated, executed and recorded electronically in computerized order management systems (OMS). Traders transmit the orders in the OMS, for example, by telephone or data links (via secure point-to-point or external third party network (network connections) to registered broker/dealers, to electronic marketplaces, or to other market intermediaries that trade in these securities. The orders are in general transmitted between the clients' OMS and the brokers' OMS using the Financial Information Exchange (FIX) protocol which has become the industry standard protocol or “language” for communicating trading orders, executions, and information between members of the financial community. The FIX Server is a computer system that allows clients to connect for the purpose of exchanging financial information messages according to the so-called FIX protocol; the source code for FIX servers is available in open source code libraries. The FIX Server may also deliver execution messages (with “done” status) to a clearing firm or the sponsoring broker after trade processing. Normally these messages will be issued at the end of the day, but most clients usually also request the system to notify their broker of executions intra-day if needed.

The FIX Server preferably supports a web configuration screen which enables an operator to set up and customize new client connections without requiring a new software release. FIX sponsoring broker clients may be configured to receive executions only. Alternatively, a sponsoring broker's FIX connection may be configured to receive a drop copy of every message sent to the sponsored client's OMS. FIX drop-copy is a process of creating a duplicate message and sending it to another destination. This is usually done to alert clearing firms of trading activity, conduct transaction cost analysis (TCA), or update position risk management systems. A drop copy of the execution is sent to the sponsoring broker(s) at the last step of the trading process. In addition to the execution message sent on each order fulfillment, the configuration options preferably include an option to send a final FIX execution message when an order is complete, with an Order Status field set to “done”, to indicate that the work on this order is complete.

While electronic trading platforms operate efficiently, there is still a need to provide filtered information to a client, in a timely manner, which selectively informs the client of products and/or services in which the client would be interested, without interfering with the order flow. There is also still a need to provide client-specific marketing tools to a broker/dealer, in particular in a multi-client environment, based on securely managed client profiles, in order to enhance marketing efficiencies and improve results.

### SUMMARY OF THE INVENTION

The present invention relates to a method and system for providing financial information in a communication network, and more particularly to a method and system for enhancing information flow by supplying clients with information/product/services relevant to their trades in securities, services and/or commodities. The present invention displays relevant information without requiring the user to query or request it.

According to one aspect of the invention, a method for providing financial information in a communication network includes the steps of transmitting client's trading information of security trades to an information exchange application, receiving at the information exchange application from a content provider financial-services-related content, filtering at the information exchange application the financial-services-related content according to the client's trading information to identify specific financial-services-related content of interest to the client, and automatically alerting the client to availability of the specific content.

According to another aspect of the invention, a system for providing financial information in a communication network includes an information exchange system connected to a client's trading system and configured to receive client's trading information. The information exchange system is configured to receive from a content provider financial-services-related content and includes a filter module for filtering the financial-services-related content according to the client's trading information to identify specific financial-services-related content of interest to the client. The system also includes a messaging module for automatically alerting the client to availability of the specific content.

According to yet another aspect of the invention, a method for alerting a client to a client-specific trading opportunity in a commodity or security includes the steps of populating a database with financial-services-related content as well as with trading information of the client's current and historic security or commodity trades, filtering the financial-services-related content in the database with respect to the client's trading information to identify specific financial-services-related content of interest to the client, and if specific financial-services-related content of interest to the client is identified, automatically generating an alert message and sending the alert message to the client.

Embodiments of the invention may include one or more of the following features. The alert message (“advertisement”) sent to the client may include an output alert, such as, e.g. an email, interface display graphic user display, fixed massage, (all referred to as instant message, or “IM”), which may be generated automatically by the information exchange application. The alert message may also include a link or a web address that connects an information consumer with an information provider.

The client's trading information may be based on the client's current or historic trading activity. Trading information which may originate from a plurality of clients may be transmitted to the information exchange application, in which case filtering may be performed on a client-specific basis. The financial-services-related content, which may be supplied to the information exchange by more than one content provider, may include financial, trading, corporate, and/or economic data, announcements about road shows, conferences, updates from brokerage houses and/or analysts, written reports, video and/or audio presentations. Advantageously, the information exchange applications may maintain confidentiality of trading information from different clients and may be prevented from disseminating trading information between clients, unless the trading information is public. More particularly, the content provider may be unaware of the identity of any of the clients.

In one embodiment, the information exchange may include a database for storing the trading information of the client and/or the financial-services-related content from the content provider. The information exchange may also include a partition for maintaining confidentiality of trading information from different clients and for preventing trading information from being disseminated between clients, unless such trading information is public.

The database of the information exchange may be populated with available content via an internet accessible GUI. Brokers can submit content to be scanned to detect relevance to clients' trading information or trading profile. If the content is deemed to be relevant by the filtering algorithm, an IM alert will be generated and sent to the client.

### BRIEF DESCRIPTION OF THE DRAWINGS

Other features and advantages of the present invention will be more readily apparent upon reading the following description of currently preferred exemplified embodiments of the invention with reference to the accompanying drawing, in which:

FIG. 1 illustrates schematically a conventional Financial Information Exchange (FIX) network;

FIG. 2 illustrates schematically a first embodiment of an Information Exchange according to the invention;

FIG. 3 illustrates schematically a second embodiment of an Information Exchange according to the invention in a multi-client environment;

FIG. 4 shows a high-level diagram of the Information Exchange according to the invention,

FIG. 5 shows a diagram of a process flow with the Information Exchange according to the invention,

FIG. 6 shows a screen shot of an individualized video clip sent from the Information Exchange to a subscriber; and

FIG. 7 shows screen shots of exemplary IM messages sent from the Information Exchange to a subscriber.

### DETAILED DESCRIPTION OF CERTAIN EXEMPLARY EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

The invention is directed, inter alia, to a system and method that monitor and evaluate trading data of financial products in real time to provide clients with targeted, up-to-date information about financial trades and investment opportunities, while leaving out information that would be of little or no interest to the client. The system, referred to hereinafter as “Information Exchange”, operates as a stand alone, neutral entity that receives duplicate messages of trading activity, for example, via the Internet, and scans the trading data in real time. The “Information Exchange” is an alert service that provides analysis of securities trading data for professional investors and combines the technical analysis with an underlying fundamental analysis to send customized trading alerts to end users, i.e. subscribers to the service. The “Information Exchange” of the invention is operated by mutual agreement between investment management firms or other entities to facilitate the trading of securities and enhance the value of the trades based on historic and/or actual securities trading data and trading opportunities provided by members of the Exchange. The “Information Exchange” uses trading information exclusively for providing advertising content, products or services of interest to an institutional client or other subscribers.

As used herein, a “security” is any ownership or creditorship interest, such as a stock certificate or bond, or any other financial instrument, contract, or transaction, such as a forward, futures, option, put, call, collar, swap, or currency contract. This definition includes, for example, any note, stock, bond, debenture, certificate of interest or participation in any profit-sharing agreement or in any oil, gas, or other mineral royalty or lease, any collateral trust certificate, investment contract, voting-trust certificate, certificate of deposit, any put, call, straddle, option, or privilege on any of the foregoing, or group or index of securities (including any interest therein or based on the value thereof. This list is not all-inclusive and may include, for example, also services and commodities. For purposes of clarity, this description will describe the trading of stock.

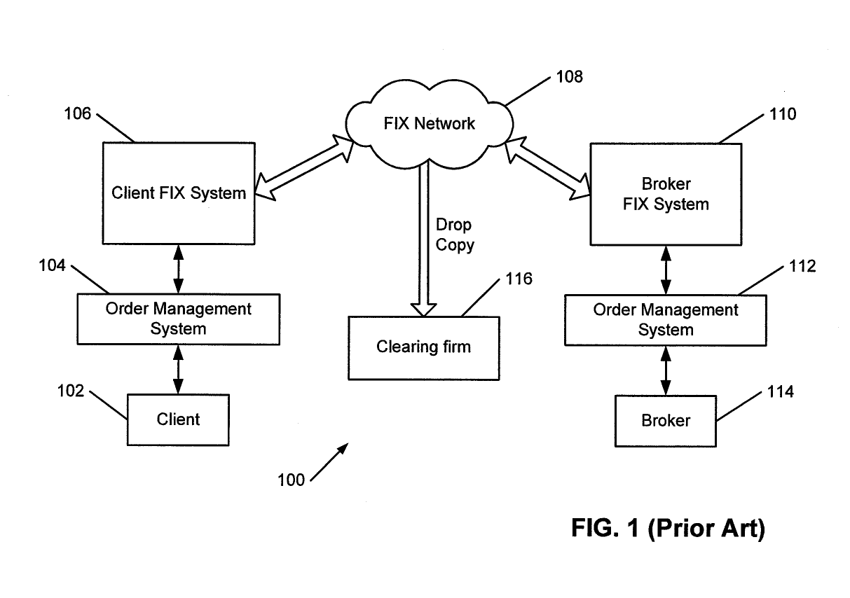

Referring first to FIG. 1, there is shown a conventional bilateral communication system 100 for equity trading between a client 102 and a broker 114 connected via a FIX (Financial Information Exchange) network 108. The FIX network 108 supports Straight-Through-Processing (STP) from Indication-of-Interest (IOI) to Allocations and Confirmations and may also include trades across the Foreign Exchange, Fixed Income and Derivative markets.

In the depicted example, a client 102 enters in a client Order Management System (OMS) 104 an order for selling or buying a security, which is then sent through the client's FIX system 106 and the FIX network 108 to the broker's FIX system 110. From there, the order is processed in the broker's OMS 112 and sent to the broker 114. Each OMS 106, 110 holds data representative of open, contemplated, or completed orders to buy and/or sell securities by traders using the trading system. It will be understood that although only one client 102 and one broker 114 are shown, more than one user can be connected at any time with the client's and broker's OMS 106, 110, and that more than one OMS and/or FIX systems can be connected on the client and broker side to the FIX network 108.

After the trade is completed, a drop copy of the execution is sent to a clearing firm 116. The clearing firm 116 may be notified of the trade immediately after each trade via a FIX Execution message, or at the end of day. The client 102 (such as an institutional client) and the broker 114 may also be notified directly after the execution of the trade.

In some trading environments, such as NASDAQ, different service levels exist for supplying trading data to participants, i.e., to the clients and brokers. NASDAQ supplies trading data to the participants via a computer network at three different service levels, known as Level I, Level II and Level III. Level I allows real-time access to the following data: (1) Inside market quotes (highest bid and lowest offer) for listed securities, (2) individual market maker quotations, as well as inside quotes for OTC Bulletin Board listed securities, (3) trade price and volume data. Level II additionally provides, among other things, real-time price quotations for each Market Maker and the inside price for each alternative trading system (ATS) in its computer network. Level III is a service limited to member dealers, allowing them to provide NASDAQ with their best bid and offer for securities in which they make markets, and receive incoming orders.

However, none of the service levels provides guidance to the traders for buying and selling securities, or information about events which may influence their buy/sell decisions.

The proposed method and system, hereinafter referred to as Information Exchange or Information Exchange application, attempts to remedy these shortcomings by providing a network of users to subscribe to the service with highly-targeted content which is matched with the expressed or derived (from their trading activity) interest of the users. To this end, the Information Exchange includes innovative, highly-effective means for deriving the detailed profile of each user and delivering content only to selected users who have expressed an interest in receiving the content.

The Information Exchange seamlessly gathers information forming the user profile specifically by passively monitoring the user's normal workflow or trading activity, for example by receiving a duplicate message of each user's electronic trading activity. The resulting profile may include a vast amount of historic and current data points for each user (client or broker), each of which can be updated in real time in response to the user's daily activity.

User access to the Information Exchange requires a user's permission and/or a subscription. Users will readily share their trade information with the Information Exchange, but not necessarily with one another, because the Information Exchange represents a completely neutral entity with the goal to only delivering pertinent content to its users. Unlike a broker who may have a conflict of interest, or the user's Order Management System (OMS) which has limited content, the Information Exchange enjoys—due to its strict confidentiality and neutrality—broad access to information of interest to clients which would otherwise be unavailable to them. In particular, in a multi-user the environment, the different users will not automatically be able to “see” the identity or particular trading patterns or spheres of interest of other users without prior, explicit authorization by all parties.

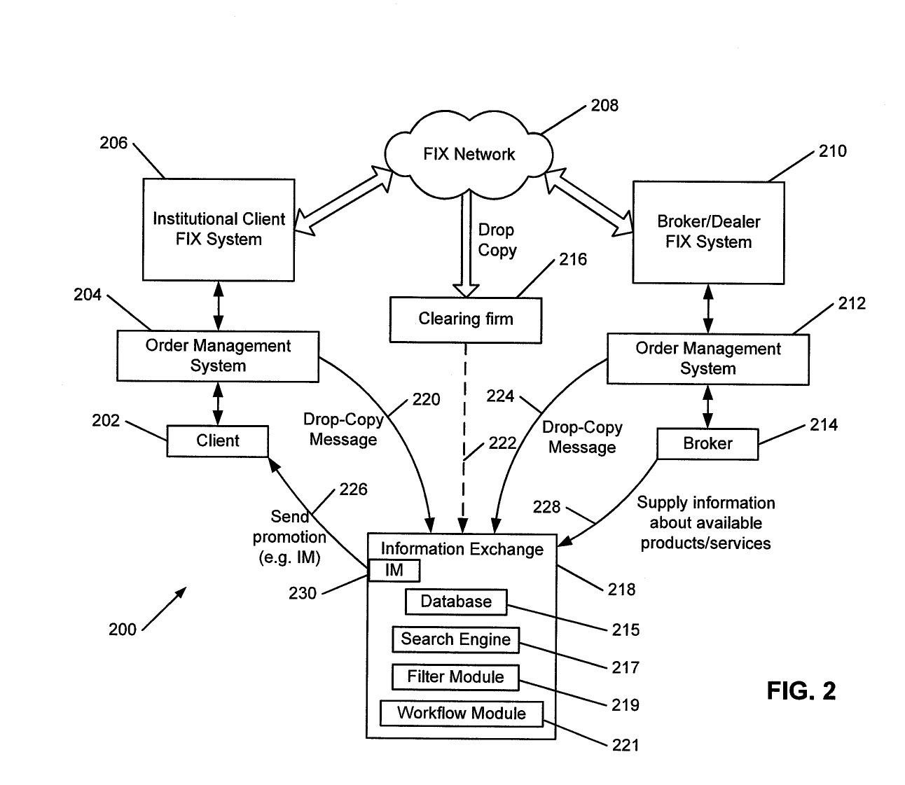

FIG. 2 shows an exemplary embodiment of a communication system 200 according to the invention. Communication system 200 includes, in addition to the elements and features associated with the FIX system illustrated in FIG. 1, a system 218, referred to hereinafter as “Information Exchange”, with a database 215, a search engine 217, and a filter module 219, which applies selection (or filter) criteria to parse and filter the trading information received from the client's OMS 204 via a drop-copy message 220 and the consolidated trading data from the FIX network 208 via a conventional Drop-Copy process, for example, by a clearing firm 216. The information, either filtered or as raw data, is stored in database 215. The “Information Exchange” 218 of the invention leverages the conventional generation of a “Drop-Copy” following a completed trade by generating a duplicate message or messages 220 of the client's trading activity and sends the duplicate message(s) to the central database 215.

Data mining of institutional client activity is common and can provide the client with information about product/services, in a timely manner, in which the client may be interested. Such information (subsequently referred to as “product” or “content”) 228 may include scheduled road shows, conferences, updates from brokerage houses and analysts, e.g. in the form of written reports, audio and/or video broadcasts which may be by personal registration only, alerts to current trading patterns at the various exchanges and, subject to permission by all participants, coordination of trading activities by multiple clients. Because the Information Exchange is confidential and requires authorization and/or subscription to its services, brokers and clients are generally not aware of the identity of other participants, either clients or other brokers, unless such sharing of information has been previously authorized. The “Information Exchange” constantly scans the data base 215 for product or content relevant to a client and, if found, transmits via IM module 230 an alert 226, for example via an IM message, notifying the client of the product's availability. In the context of this application, the terms “product”, “service” and “content” will be used interchangeably and should therefore be interpreted as having identical meaning.

The information is stored in the database 215 of Information Exchange 218, with the search engine 217 processing the data using conventional search and association algorithms to extract the information the client is interested in. The content message, such as an IM message 226, can be derived, for example, from available product comparison against recent trading activity. In addition, the database can also be populated by the broker 214 with products/services the broker wants to promote. Such promotional information 228 can be entered, for example, on the broker's graphic user interface (GUI) and sent to the Information Exchange 218 via VPN. The filter module 219 matches the product information with the client's historic and actual trades to ensure that the client only receives only those customized messages and alerts of interest to the client. This facilitates searching for product information for a client by the search module 217 and eliminates “noise” in the system.

Messages 220, 222, 224 can be readily disseminated to a client, since the participating clients are “integrated” with the Information Exchange 218 and will only require a one time certification with the OMS (pending the client's desire to participate). The Information Exchange 218 cooperates with the client's and broker's Order Management Systems (OMS) 204, 212 and may share revenues on a “per click” basis. The Information Exchange 218 may transfer information via any known interfacing technology, including, but not limited to, transmission control protocol/Internet protocol (TCP/IP), satellite, cellular, and/or radio frequency (RF) links, or some combination thereof. The links may pass through one or more intermediate data processing systems, such as telephone switches or Internet servers, before reaching a trading system. In embodiments where data travels over shared links, such as embodiments where data travels over the public Internet or Virtual Private Network (VPN), the data may be encrypted using a secure protocol, such as the secure sockets layer (SSL). This approach minimizes integration requirements, alleviate time to market issues, and keep costs to a minimum. All that is required when transmitting relevant information and product to the end client is an IP address which can be used to transmit a simple “Instant Messenger” (IM) message 226. Examples of such IM messages are provided below. Receiving as well as transmitting data is therefore extremely cost-effective due to the use of existing technologies and transmission protocols.

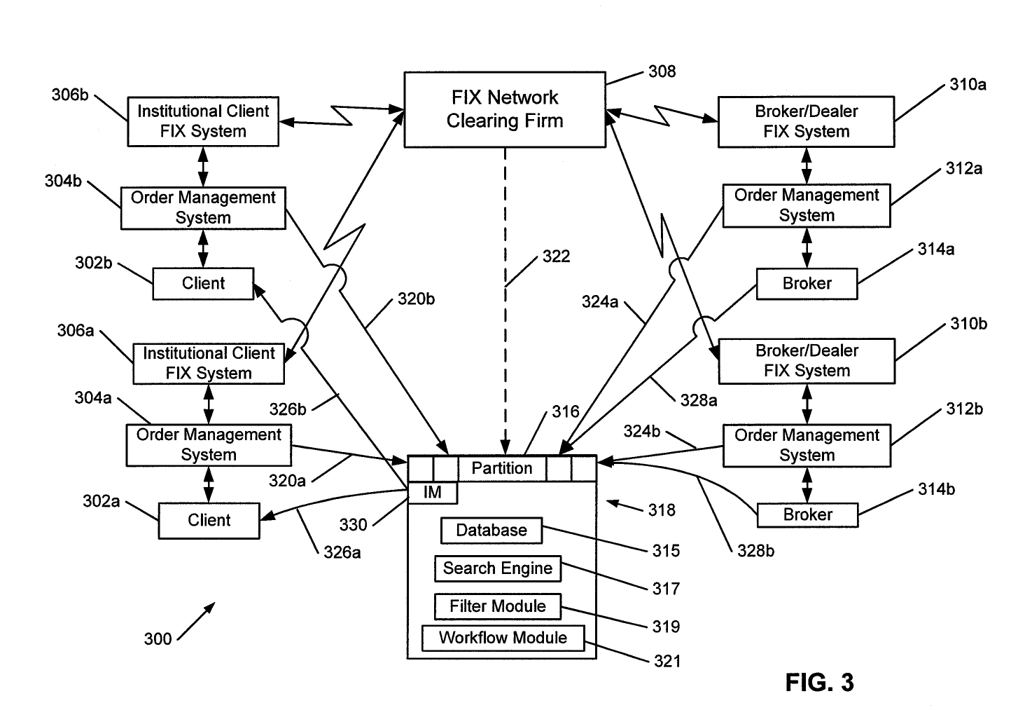

FIG. 3 shows an expanded Information Exchange system 300 communicating with several client FIX systems 306a, 306b and several broker FIX systems 310a, 310b which are connected, as in FIG. 2, via a FIX network 308. Associated with these systems 306, 310 are corresponding Order Management Systems 304a, 304b, 312a, 312b, as well as client stations 302a, 302b and broker stations 314a, 314b. The various FIX systems 306a, 306b, 310a, 310b can be connected to the FIX network 308 through suitable point-to-point or network connections, such as the illustrated exemplary WAN links. System 300 also produces a conventional drop-copy at the end of the trade, as described above, which may be forwarded to Information Exchange 318, as before.

As described above with reference to FIG. 2, the Information Exchange 318 also includes a database 315, a search engine 317, and a filter module 319, and receives from the clients' OMS 304a, 304b via respective drop-copy messages 320a, 320b information about the clients' trades, either executed or unexecuted, and receives likewise trading data from the brokers' OMS 312a, 312b, as well as brokers' information about products deemed to be of interest to one or more clients 302a, 302b. In this multiuser environment, where a plurality of clients and/or brokers are allowed access to the Information Exchange 318, the space in the Information Exchange 318 accessible to the users is partitioned by partition 316, which can be configured by a system administrator of the Information Exchange 318, so that in general different clients can be denied access to other clients' or brokers' information. Likewise, brokers may not be aware of other participants in the Information Exchange, unless specifically authorized. Access can be granted, for example, with specific user names and passwords supplied, for example, by the administrator. The partition 316 therefore maintains anonymity and confidentiality of all participants.

Nevertheless, clients 306 authorized to participate in the Information Exchange 318 may be able to receive information from multiple brokers with relevant information on traded securities almost at the same time an order is entered, thereby greatly reducing the time to process the information as well as greatly increasing the trading efficiency. Because the Information Exchange is based on active participation of the interested parties, advantageously based on subscription, potential clients are already pre-qualified as interested in the product, thus increasing substantially the efficiency of the distribution of the information and the response time to the information.

The Information exchange 318 can be connected to client stations 302a, 302b via point-to-point connection, or a network, such as LAN, WAN or the Internet. The communication channels are preferably encrypted using standard encryption algorithms. The client stations 302a, 302b may include a browser and an IM client, and it will be understood that not all features need to be incorporated in the client stations.

Using a conventional system architecture and transmission protocol aids in developing, upgrading and maintaining the system. As long as the interfaces, including the message and transmission protocol, between the systems are specified (e.g., TCP/IP), each component can be independently modified without affecting any of the other components.

As mentioned above, the Information Exchange 318 “mines” trading or transaction information received from clients as well as from brokers, and in addition content (also referred to as “product”) from the brokers and communicates relevant information to clients, for example, by sending IM alerts. That is, after subscribing to the Information Exchange service and configuring an individual profile, a client interacts with the Information Exchange via a “chat” window, for example, on a public IM Client. This is a common activity familiar to users. However, unlike conventional chat sessions, the chat will initially be unidirectional and the sender of messages is a computer. The Information Exchange has built an application that accepts Instant Message Command from an IM Client as input, without requiring an addition application or GUI installed at the client's location. For example, the client can send an Instant Message to the Information Exchange Instant Messenger Account such as “Add”. The application will then expect a symbol, or string of symbols to add to the client profile.

In alternative embodiments, the system may include more interactive channels than just IM Alerts. One exemplary infrastructure may include:
Plug-ins to Public IM Networks—these are rich clients that can be downloaded from the Internet and installed directly into the public IM clients (i.e., Yahoo, MSN, ICQ, Jabber).
Private IM Network—these would replace the public IM Networks and clients. Only “paid” subscribers and publishers of the Information Exchange would be able to participate.
Desktop Application—similar to the Private IM Network, but without the Messenger component.
Integration with conventional click-stream analysis tools that can further improve the product suggestions provided by the system.
Embed the Output Alert into a FIX message to allow the InfoExchange Alerts to be displayed in an OMS or other system.
Allow the IM Alert to be sent via E-Mail.
Allow the IM Alert to be displayed via Website.
Allow the IM Alert to be displayed via Ticker Display or other Graphic User Interface (GUI) Application.

The Information Exchange 318 may include:

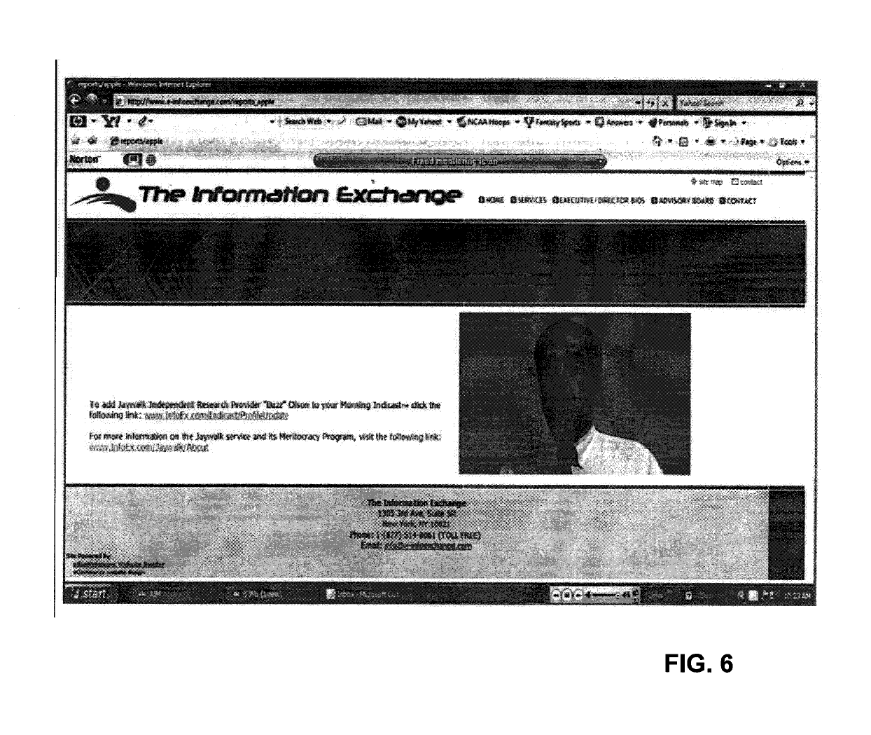

An IM Module 330 implemented initially as a one-way communication mechanism that allows IM alerts to be sent to different public IM networks (Yahoo, AOL, MSN, ICQ and the like). Messages and alerts for distribution will be inserted in a communication queue with proper routing information. IM messages will be “indicasted”, meaning they will be transmitted to a single client or to a designated group of clients. For example, individualized versions of written reports, audio and/or video files may be sent to a client or clients reflecting the clients' individual interests. One example of an “Indicast” (short for “individual casting”, as opposed to broadcasting) is shown in FIG. 6 in form of a screen shot of an analyst's video presentation sent to a subscriber based on the subscriber's user profile. Indicasting is to be distinguished from, for example, traditional broadcasts from brokerage houses. The IM Module 330 may advantageously include a presence detector that updates the Information Exchange database with the current status of the user. Based on this status, any messages destined for inactive users will be re-inserted into the communication queue.

The Information Exchange 318 may also be also configured to receive FIX Single Order and Order List drop copies. Orders and requests can be transported by FIX session, e-mail, TCP/IP or other suitable protocols. One or more sessions may be open at one time in support of the FIX sessions.

A FIX protocol engine receives the duplicate drop copies, transforms the information in the duplicate drop copies into an internal format, and stores the reformatted messages as part of a queue for further processing.

A Web Server or an Application Server implemented on the Information Exchange 318 will allow subscribers, clients, brokers, and other authorized entities, such as publishers, to manage their accounts and to interact with the Information Exchange 318. The following interactive features will be available to different types of users:
An Administrator can manage User Accounts (Create, Modify, Delete operations), send notifications to User Accounts, and define metrics for accounting and billing.
A Subscriber can manage all relevant contact, billing and user account information for a buyer of information. A Subscriber can also create, modify and delete specifications relating to FIX OMS drop copy orders. A Subscriber can further specify client filter criteria, i.e., the type of information he wishes to receive, and a time for receiving such information.
A Publisher can manage (create, modify and delete) all relevant contact, billing and user account information for a seller of information. A Publisher can also specify publisher filter criteria, e.g. product profiles, i.e., the type of information to be published and a time for publishing such information. The publisher can furthermore create groups of different types of information and can add new publications as well as and view, modify or delete current publications.

The Database 315 of the Information Exchange 318 may also store business revenue data and thus requires a high degree of survivability. In one embodiment (not shown), a hot backup is provided to store essential data at an off-site location.

A Workflow module 321 (221 in FIG. 2) encompasses all the workflows and business rules required to properly interpret the different events generated by the other components in the context of the Information Exchange 318. It also includes the click-stream analysis features of the system that will allow it to learn user behavior and provide the most desired product suggestions to subscribers.

It will also be appreciated by those skilled in the art that the Information Exchange 318 may comprise additional types of modules, circuitry, etc., not shown in FIGS. 2 and 3 in order to avoid unnecessarily obscuring understanding of the invention. For example, the Information Exchange 318 may include one or more microprocessors, network connection circuitry, and/or data storage areas, such as read-only memory (ROM), random-access memory (RAM), CD-ROM, DVD, tape drive, hard disk (HD), and/or other types of storage areas. It will also be appreciated that the functionality of the aforedescribed multiple components of the Information Exchange described herein can be combined into a single module and the functionality of a single module can be split or shared among multiple modules. Moreover, alternative embodiments of the present invention may lack one or more of the modules described herein and/or have modules not described herein, without affecting the operation of the Information Exchange 318 according to the invention.

The systems depicted in FIGS. 1 through 3 can utilize any networking technology that supports bi-directional transfer of data among the OMS, workstations, and external networks. In a typical embodiment, the network installed at a financial institution is a private local area network (LAN) that interfaces with one or more external gateways. In alternate embodiments, the network may be wireless, connect devices over a wide area, and/or at least partially carry data over a public network (such as the Internet). Other network components, such as a firewall, may also be present. Those of ordinary skill in the art will recognize that many different types of networks can perform the functionality described herein.

For the most part, the system will remain static and awake following the arrival of an event. Examples of events and their sources are web events which may include trading activity, account changes for publishers or subscribers, subscription changes, publication changes, and selection of alert links. Another example of an event is an IM event which may indicate when a client is logged in. Events may also include messages sent back, e.g. via IM, to the Information Exchange 318.

Other examples of events are scheduled events, such as “Good Morning” and “Good Night”, FIX Events (Single Order Drop Copy, Order List Drop Copy), and Management Events, such as Notifications.

Events handled by the workflow in module 321 can be classified as follows:
Events that directly modify subscriber preferences. These types of events are generated by the account owner through interaction with an Information Exchange web form that allows the account owner to configure his/her account.
Events that indirectly modify subscriber preferences by association, for example, when the subscriber himself/herself or a subscriber from a group of subscribers selects a particular product by clicking on an IM alert or on an advertisement on the Information Exchange web site. Alerts may also provide a link to a web address that connects a buyer of securities with a seller of securities. These are events that will trigger internal associations between products and the subscriber or groups of subscribers that can be used to reinforce certain product suggestions in the future.
Events that may generate an alert, like a drop copy or scheduled “Good Morning” event. These events basically trigger rules which either publish pre-computed sets of information or select on-the-fly the proper products to publish as IM alerts.
Events that generate targeted web pages. These events are those generated by the subscriber selecting a link on an IM Message. Sufficient information is provided to the web server for generating a suitably customized web page to provide the information to the subscriber for viewing. This web page may publish other similar products and advertising.

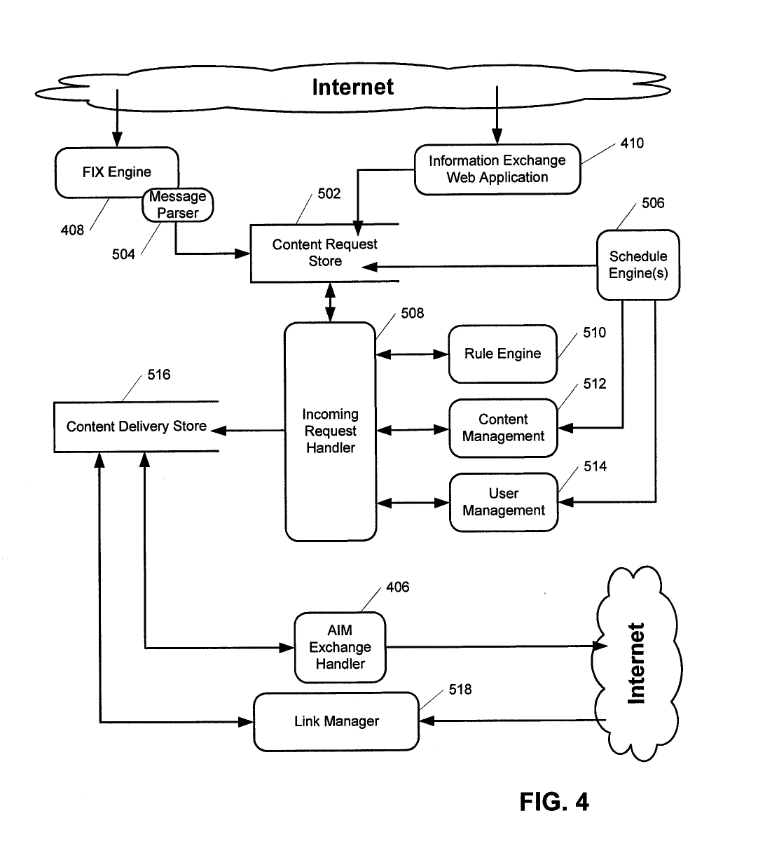

FIG. 4 shows a more detailed diagram of the system 300 of FIG. 3 with the Information Exchange 318 according to the invention. Like reference numerals indicate identical or similar components.

The Information Exchange web application 410 is the core client/broker interface into the overall Information Exchange system. This environment is utilized by Information Exchange System Administrators to perform various administrative tasks, such as user maintenance and reporting for billing, etc., by content providers, such as brokers, as a mechanism for entering information into the system, for example, into the content request store 502, and by content subscribers, such as clients, for maintaining their own profile information and to obtain various account reports. The content request store maintains data in form of a table structure which includes incoming requests for content to be generated.

The FIX Engine 408 leverages on existing multi-threaded high performance FIX servers to provide a full-feature FIX integration engine prepared to receive single order notifications from a subscribing client's OMS. A Message Parser 504 works in conjunction with the FIX Server to parse and interpret the content received by the FIX engine 408, for example, the specified account and symbol contained within the FIX message, and sends these messages to the content request store 502. The content request store 502 also receives messages from one or more schedule engines 506 which perform regularly scheduled processes that are executed to provide a mechanism for the system to generate information requests, instead of relying solely on FIX events to initiate the requests. For example, a schedule engine 506 may include a Morning Schedule Engine which is executed each morning prior to system startup to generate personalized “Good Morning” messages to be delivered to registered users. The schedule engine 506 may also include a Conference Schedule Engine which continually monitors new content relating to vendor conferences entered into the system and delivers this type of (optionally filtered) information to users registered to receive this specific type of content. The schedule engine 506 may further include a Roadshow Schedule Engine which continually monitors new content relating to vendor road shows entered into the system and delivers this type of information to users registered to receive this specific type of content. Other types of schedule engines may be added or substituted depending on the application.

Incoming request handler 508 which communicates with the content request store 502 is a continually running component that provides the core distribution functionality of the Information Exchange system 318. By constantly polling to determine when new requests for information are received, this component interrogates the Information Exchange system to determine if the request should be satisfied based on the user's profile setup. As shown in FIG. 4, incoming request handler 508 is also in communication with a Rule Engine 510 which provides system administrators with the tools necessary to maintain and manage the overall Information Exchange system 318. For example, Rule Engine 510 performs lookup maintenance which allows the administrator to dynamically maintain the values that are presented within drop down lists throughout the system. Initial lookup types that can be maintained include User Type, Alert Type, Rule Type, Delivery Status, User Status, and Report Type. Incoming request handier 508 also communicates with Content Management Engine 512, which provides content providers with mechanisms for entering content into the system to be distributed to subscribers. The web application 410 provides mechanisms to enter individual content submissions or upload a formatted file containing multiple content submissions in a single action.

User Management Engine 514 gives the system administrator the ability to create and manage users defined to the system. A user is defined as any individual who is authorized to logon to the web application or have single order notifications submitted via the system's FIX engine. User information maintained by the system may include the following:

Basic personal information (name, phone, email address, IM screen name, etc);

Profile information (for content subscribers to define what types of content they wish to receive); and

Rule definitions (initial release includes only the ability to filter content based on symbol).

Incoming request handler 508 communicates information to be sent to a client/recipient, for example, as an IM message, to Content Delivery Store 516 which includes a table structure containing every generated complete message to be sent to a recipient. Content Delivery Store 516 is in communication with an AIM message handler 406 which sends the IM messages to the clients, as described above with reference to FIGS. 2 and 3. Messages can be transmitted via the Internet. Content Delivery Store 516 is also in communication with a Link Manager 518 which handles the link requests made by clients from within their messenger clients. This process exposes a series of Java servlets or applets that are invoked by the links that are generated and delivered to the clients.

Based on information entered when the content was submitted, the use of some links may be restricted by, for example, limiting the number of times the link is available or cancelling the link by a certain date/time. By managing all links through this mechanism, all desired control, logging, and tracking can be achieved.

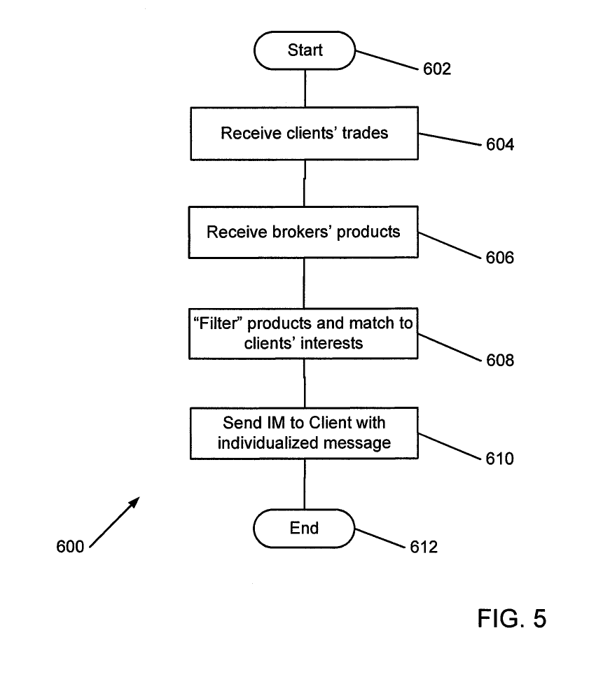

FIG. 5 shows a flow diagram of process 600 for supplying clients with individualized messages, for example, IM messages, from the Information Exchange 318 according to the invention. Process 600 begins at step 602. At step 604, the Information Exchange 318 receives information about a client's trade. At step 606, the Information Exchange 318 receives from a broker information of potential relevance for a client. As already mentioned above, such information may advantageously be determined from previously completed (e.g. on-line) questionnaires (see examples provided below), whereby the client can set “preferences” as to which information, product and services he would like to be alerted to and which ones would be viewed as a nuisance. These preferences may be processed, for example, by filter module 319 (see FIG. 3) based on “filter criteria” established by the Information Exchange 318 in cooperation with the client(s). This “filtering” or “customization” may be initially performed by applying a simple associative matrix with the filter criteria, with the possibility to expand the system to longer matrix chains allowing other remotely related systems to be linked. In one embodiment, this may be accomplished by employing explicit rules; alternative embodiments may employ a genetic algorithm or an adaptive neural network which allow the system to learn from the results provided to the subscribers and their feedback. The subscribers themselves will then be actively involved in guiding the results. For example, if a client is interested in earnings reports on stocks that trade with a certain volume all earnings reports may be provided initially, and the client can “prune” the results if the results tend to be too numerous.

The ability to “filter” or “customize” may also be offered to the Broker who can populate the Information Exchange (or database 215, 315) with available product, for example, via an Internet-accessible graphic user interface (GUI). The Broker can choose (usually by assets under management) exactly who he wishes to target, thereby maximizing the value of the service to the member (examples provided below). With this approach, the member's ability to market product is greatly enhanced, because this information is only distributed to clients who have already declared themselves predisposed to receive it. Theoretically, this should greatly increase the hit rate. At step 608, the Information Exchange processes in filter module 319 (FIG. 3) the information received from the broker/dealer and passes only information about those products and services that may be of interest to a particular institutional client according to the client's indicated preferences. At the filtering step 608, the Information Exchange may analyze historic and current trading patters, i.e., patterns that have formed in the past or are currently forming, and then, at step 610, sends an alert, e.g. an IM message, to the client with customized recommendations for a product and/or service. Because the analyzed patterns may cover a longer time frame, the alerts may not be based on current trading activity alone, but may be long-term in nature. Process 600 ends at step 612.

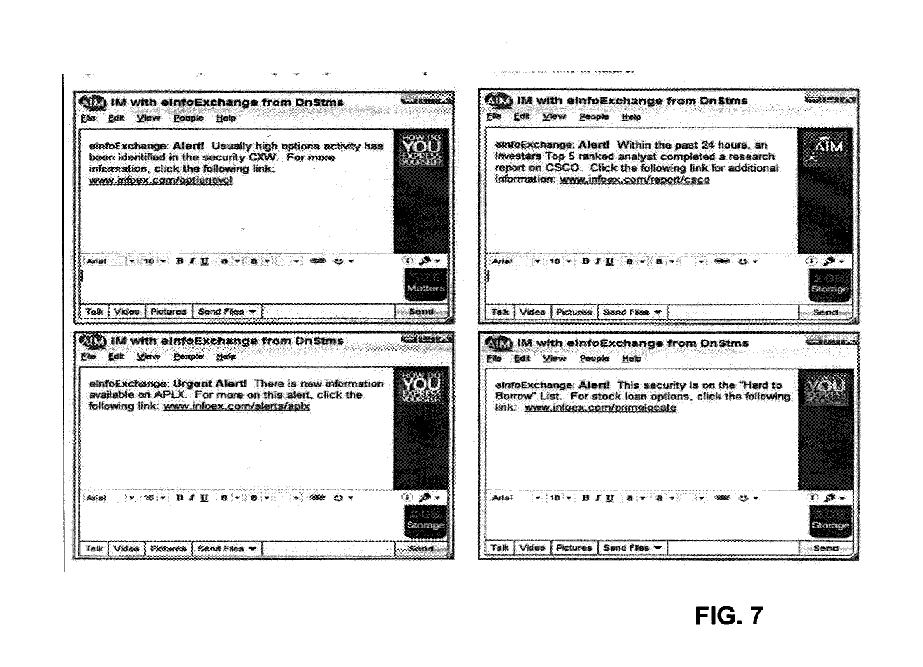

FIG. 7 shows four representative examples of IM messages sent from the Information Exchange to a client. The illustrated IM messages are to be understood merely as examples, and the contents and delivery of the IM messages can be tailored to the client's preferences. The IM messages can be transmitted over network or point-to-point connections, and can be delivered to computers, workstations and/or mobile devices, such as mobile phones, PDAs and the like.

The aforedescribed method and system of an Information Exchange according to the invention aligns the interests of the investor, broker, and system vendor. The Institutional client (subscriber) receives from the Information Exchange customized messages or alerts about financial product and/or services of potential interest to the client. The messages/alerts may include reports, articles, announcements, video and audio presentations, and the like. The client is then in a better position to make an informed decision when trading securities, which is expected to improve portfolio performance because all parties participate in value creation. These economic factors should likely contribute to an economic success of the Information Exchange model.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, the disclosed systems and methods can also be applied in commodities trading or in trading of services. Substitutions of elements from one described embodiment to another are also fully intended and contemplated. It is also to be understood that the drawings merely conceptual in nature. It is the intention, therefore, to be limited only as indicated by the scope of the claims appended hereto.

What is claimed is:

1. A method for providing financial information in a communication network, comprising:
transmitting client's trading information of security trades to an information exchange application,
receiving at the information exchange application from a content provider financial-services-related content,
filtering at the information exchange application the financial-services-related content according to the client's trading information to identify specific financial-services-related content of interest to the client, and
automatically alerting the client to availability of the specific content.

2. The method of claim 1, wherein the client's trading information is based on the client's current or historic trading activity.

3. The method of claim 1, wherein alerting the client includes sending an instant message (IM) to the client.

4. The method of claim 3, wherein the IM is generated automatically by the information exchange application.

5. The method of claim 1, wherein the financial-services-related content comprises financial, trading, corporate, or economic data, announcements about road shows, conferences, updates from brokerage houses or analysts, video and audio presentations, or a combination thereof.

6. The method of claim 1, wherein the information exchange application is accessed via a graphic user interface of a browser.

7. The method of claim 3, wherein the alert includes a link or a web address that connects a buyer of securities with a seller of securities.

8. The method of claim 1, wherein trading information from a plurality of clients is transmitted to the information exchange application, and wherein filtering is performed on a client-specific basis.

9. The method of claim 8, wherein the information exchange applications maintains confidentiality of trading information from different clients and is prevented from disseminating trading information between clients, unless the trading information is public.

10. The method of claim 1, wherein financial-services-related content is received at the information exchange application from a plurality of content providers.

11. The method of claim 1, wherein the content provider is unaware of the client's identity.

12. The method of claim 1, wherein access to the information exchange application requires prior authorization by an administrator of the information exchange application.

13. A system for providing financial information in a communication network, comprising:
an information exchange system connected to a client's trading system and configured to receive client's trading information, the information exchange system further configured to receive from a content provider financial-services-related content,
the information exchange system comprising a filter module for filtering the financial-services-related content according to the client's trading information to identify specific financial-services-related content of interest to the client; and
a messaging module for automatically alerting the client to availability of the specific content.

14. The system of claim 13, further comprising a database for storing the trading information of the client or the financial-services-related content from the content provider, or both.

15. The system of claim 13, further including a partition which maintains confidentiality of trading information from different clients and prevents trading information from being disseminated between clients, unless the trading information is public.

16. A method for alerting a client to a client-specific trading opportunity in a commodity or security, comprising:
populating a database with financial-services-related content;
populating the database with trading information of the client's current and historic security or commodity trades;
filtering the financial-services-related content in the database with respect to the client's trading information to identify specific financial-services-related content of interest to the client; and
if specific financial-services-related content of interest to the client is identified, automatically generating an alert message and sending the alert message to the client.
